(19) United States
(12) Patent Application Publication
(10) Pub. No.: US 2024/0011125 A1
(43) Pub. Date: Jan. 11, 2024

(54) Repeated Distillation/Sublimation of Rare Earth Elements

(71) Applicant: SHINE Technologies, LLC, Janesville, WI (US)

(72) Inventors: Eric Van Abel, Lino Lakes, MN (US); Charles Shackett, Janesville, WI (US)

(73) Assignee: SHINE Technologies, LLC, Janesville, WI (US)

(21) Appl. No.: 18/218,960

(22) Filed: Jul. 6, 2023

Related U.S. Application Data
(60) Provisional application No. 63/358,849, filed on Jul. 6, 2022.

(51) Int. Cl. C22B 59/00; C22B 3/26; C22B 3/22

(52) U.S. Cl. CPC C22B 59/00; C22B 3/26; C22B 3/22

(57) ABSTRACT

A method including sublimating or distilling an ytterbium composition from an initial solid composition comprising ytterbium and lutetium in an inert or reduced pressure environment and at a first average temperature for a first sublimation/distillation period to leave a lutetium composition comprising a higher weight percentage of lutetium than was present in the initial solid composition, collecting the ytterbium composition; retaining the ytterbium composition for a waiting period to form a decayed ytterbium composition, wherein the waiting period is longer than the first sublimation/distillation period; and subsequent to the waiting period, sublimating or distilling a refined ytterbium composition from the decayed ytterbium composition in an inert or reduced pressure environment and at a second average temperature for a second sublimation/distillation period to leave a waste composition.

### TECHNOLOGY

The present disclosure is generally related to the separation of rare earth elements and their purification. More particularly, it is related to the isolation and purification of lutetium from an irradiation target that includes other rare earth metals, such as ytterbium.

### BACKGROUND

Lutiteum-177 (Lu-177) is a radioisotope that is used in the treatment of neuro endocrine tumors, prostate, breast, renal, pancreatic, and other cancers. In the coming years, approximately 70,000 patients per year will need Lu-177 during their medical treatments.

Accordingly, a need exists for improved techniques of separating and purifying radioisotopes, such as Lu-177.

### SUMMARY

According to a first aspect of the present disclosure, a method includes sublimating or distilling an ytterbium composition from an initial solid composition comprising ytterbium and lutetium in an inert or reduced pressure environment and at a first average temperature in a range of from 400° C. to 2000° C. for a first sublimation/distillation period to leave a lutetium composition comprising a higher weight percentage of lutetium than was present in the initial solid composition, collecting the ytterbium composition; retaining the ytterbium composition for a waiting period to form a decayed ytterbium composition, wherein the waiting period is longer than the first sublimation/distillation period; and subsequent to the waiting period, sublimating or distilling a refined ytterbium composition from the decayed ytterbium composition in an inert or reduced pressure environment and at a second average temperature in a range of from 400° C. to 2000° C. for a second sublimation/distillation period to leave a waste composition.

A second aspect includes the method of the first aspect and further includes collecting the refined ytterbium composition.

A third aspect includes the method of the second aspect and further includes forming the refined ytterbium composition into an ytterbium target.

A fourth aspect includes the method of the third aspect and further includes irradiating the ytterbium target with neutrons to form a recycled solid composition comprising ytterbium and lutetium.

A fifth aspect includes the method of the fourth aspect and further includes sublimating or distilling an ytterbium composition from the recycled solid composition in an inert or reduced pressure environment and at a third average temperature in a range of from 400° C. to 2000° C. for a third sublimation/distillation period to leave a subsequent lutetium composition comprising a higher weight percentage of lutetium than was present in the recycled solid composition.

A sixth aspect includes the method of the fifth aspect, wherein the first average temperature, the second average temperature, and the third average temperature are equal or differ by less than 100° C.

A seventh aspect includes the method of any of the previous aspects, wherein the refined ytterbium composition comprises 0.1 wt. % Lu-175 or less.

An eighth aspect includes the method of any of the previous aspects, wherein the refined ytterbium composition comprises 0.01 wt. % Lu-175 or less.

A ninth aspect includes the method of any of the previous aspects, wherein the refined ytterbium composition comprises 0.005 wt. % Lu-175 or less.

A tenth aspect includes the method of any of the previous aspects, wherein the waste composition comprises Lu-175 and at least one of one or more ytterbium oxides, one or more ytterbium silicates, lanthanum, iron, aluminum, nickel, copper, cerium, tin, erbium, cobalt, silicon, chromium, tantalum, titanium, molybdenum, manganese, and mixtures and alloys thereof.

An eleventh aspect includes the method of the tenth aspect, wherein the waste composition comprises 10 mg or more of an ytterbium oxide and the method further comprises dissolving the ytterbium oxide to form a dissolved ytterbium oxide and metalizing the dissolved ytterbium.

A twelfth aspect includes the method of any of the previous aspects, wherein the ytterbium composition comprises Yb-176 and Yb-175 and during the waiting period the Yb-175 decays partially into Lu-175 to form the decayed ytterbium composition and sublimating or distilling the refined ytterbium composition from the decayed ytterbium composition separates Yb-176 and Lu-175.

A thirteenth aspect include the method of any of the twelfth aspect, wherein the refined ytterbium composition comprises Yb-176 and the waste composition comprises Lu-175.

A fourteenth aspect includes the method of any of the previous aspects, wherein the waiting period is at least 1 week.

A fifteenth aspect includes the method of any of the previous aspects, wherein the waiting period is at least 5 weeks.

A sixteenth aspect includes the method of any of the previous aspects, wherein the waiting period is at least 8 weeks.

A seventeenth aspect includes the method of any of the previous aspects, wherein, during the waiting period, 99% or more of the Yb-175 present in the ytterbium composition decays into Lu-175.

An eighteenth aspect includes the method of any of the previous aspects, wherein, during the waiting period, 99.9% or more of the Yb-175 present in the ytterbium composition decays into Lu-175.

A nineteenth aspect includes the method of any of the previous aspects, wherein the inert or reduced pressure environment is a reduced pressure environment comprising a reduced pressure in a range from 1×10⁻⁸ to 2000 torr.

A twentieth aspect includes the method of the nineteenth aspect, wherein the reduced pressure is 1×10⁻³ or less.

A twenty-first aspect includes the method of any of the previous aspects, wherein the first average temperature is in a range of from 450° C. to 1500° C.

A twenty-second aspect includes the method of any of the previous aspects, wherein the first average temperature is less than 700° C.

A twenty-third aspect includes the method of any of the previous aspects, wherein the first average temperature and the second average temperature are equal or differ by less than 100° C.

A twenty-fourth aspect includes the method of any of the previous aspects, further including subjecting the lutetium composition to chromatographic separation to further enrich the lutetium in the lutetium composition.

A twenty-fifth aspect includes the method of the twenty-fourth aspect, further including dissolving the lutetium composition in an acid to form a dissolved lutetium solution, adding a chelator to the dissolved lutetium solution and neutralizing with a base to form a chelated lutetium solution comprising both chelated lutetium and ytterbium, and subjecting the chelated lutetium solution to chromatographic separation, collecting a purified, chelated lutetium fraction, and de-chelating the lutetium to obtain purified lutetium.

A twenty-seventh aspect includes the method of any of the previous aspects, wherein the initial solid composition is contained in a crucible of a sublimation/distillation apparatus and subliming or distilling ytterbium from the initial solid composition comprises heating the crucible such that the ytterbium composition sublimates, distills, or both sublimates and distills from the initial solid composition and collects on a collection substrate of the sublimation/distillation apparatus.

A twenty-eighth aspect includes the method of any of the previous aspects, wherein the refined ytterbium composition comprises a higher weight percentage of ytterbium than was present in the decayed ytterbium composition.

A twenty-ninth aspect includes the method of any of the previous aspects, further comprising subjecting the lutetium composition to a non-aqueous separation technique to further enrich the lutetium in the lutetium composition.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a T-x-y diagram for lutetium and ytterbium at a constant pressure of 1 μTorr;

FIG. 2 schematically depicts a chamber for the sublimation of the ytterbium and lutetium according to one or more embodiments shown and described herein; and

FIG. 3 depicts a flow chart outlining a method of repeated sublimation of ytterbium according to one or more embodiments shown and described herein.

### DETAILED DESCRIPTION

Referring generally to the figures, embodiments of the present disclosure are directed to methods of repeated separation of ytterbium compositions from solid compositions that comprise ytterbium and lutetium. In particular, the method includes sublimating an ytterbium composition from an initial solid composition comprising ytterbium and lutetium, collecting both the sublimated ytterbium composition and a remaining lutetium composition, which may compromise high purity isotopes of lutetium, such as lutetium-177 (Lu-177), and reprocessing the ytterbium composition, such that the collected ytterbium composition may be used to collect additional high purity lutetium, such as additional Lu-177. Lu-177 is used in the treatment of neuro endocrine tumors, prostate, breast, renal, pancreatic, and other cancers. In the coming years, approximately 70,000 patients per year will need no carrier added Lu-177 during their medical treatments. Lu-177 is useful for many medical applications, because during decay it emits a low energy beta particle that is suitable for treating tumors. It also emits several gamma rays, two of which are used for diagnostic testing. Isotopes with both treatment and diagnostic characteristics are termed “theranostic.” Not only is Lu-177 theranostic, but it also has a 6.65-day half-life, which allows for more complicated chemistries to be employed, as well as allowing for easier global distribution. Lu-177 also exhibits chemical properties that allow for binding to many bio molecules, for use in a wide variety of medical treatments.

There are two main production pathways to produce Lu-177. One is via a neutron capture reaction on Lu-176; Lu-176 (n,γ) Lu-177. This production method is referred to as carrier added (ca) Lu-177. A carrier is an isotope(s) of the same element (Lu-176 in this case), or similar element, in the same chemical form as the isotope of interest. In microchemistry the chemical element or isotope of interest does not chemically behave as expected due to extremely low concentrations. The Lu-176 effectively dilutes the interaction of Lu-177 with receptor sites in the body, reducing treatment efficacy. Moreover, isotopes of the same element cannot be chemically separated, and require mass separation techniques. The carrier method, therefore, results in the produced Lu-177 having limited medical application.

The second production method for Lu-177 is a neutron capture reaction on ytterbium-176 (Yb-176) (Yb-176(n,γ)Yb-177) to produce Yb-177. Yb-177 then rapidly (t_{1/2} of 1.911 hours) beta-decays into Lu-177. An impurity of Yb-174 is typically present in the Yb-176, leading to a further impurity of Lu-175 in the final product. This process is considered a “no carrier added” process. The process may be carried out as ytterbium metal or ytterbium oxide.

The present disclosure describes a process for the separation of Yb and Lu obtained from a no carrier added process. The process includes a distillation/sublimation step to purify the Lu and remove excess Yb after irradiation. The excess Yb may be further processed and recycled (e.g., irradiated with neutrons) for a subsequent use, and the process may also include further purification of the lutetium using a chromatographic separation process or other separation process, such as a non-aqueous separation process. Due to the limited amounts of material that may be processed at any one time during the chromatographic separation process or other separation process, the process of enriching the Lu prior to chromatographic or other separation processes allows for scaling of the recovery of the product Lu at a much greater level than previously obtainable. The combined distillation/sublimation and chromatographic or other separation processes allows for use of larger targets, and isolation of the product via distillation that can then be passed to the chromatographic process. Moreover, the handling of metal targets allows for larger targets to be used more efficiently with more economic recovery. As the metal targets stay metal during processing, the Yb can readily be incorporated into new targets with minimal manipulation, less labor, and less processing equipment. Furthermore, the use of this sublimation process with existing separation technologies allows the use of lower flux neutron facilities, which greatly improves the possibilities and business competitiveness of irradiating Yb targets.

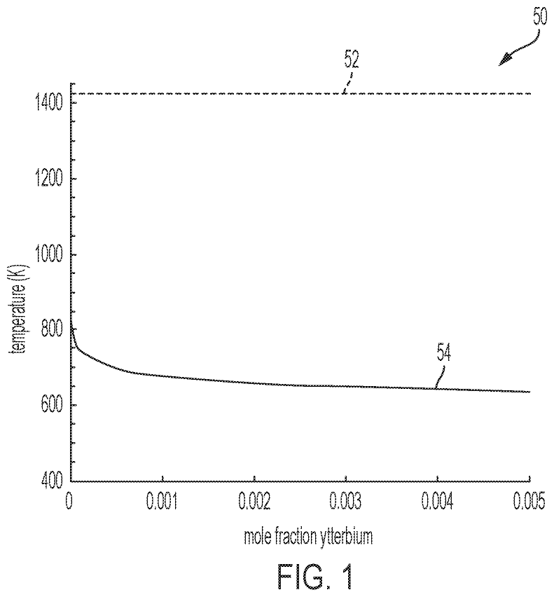

The separation of Yb and Lu may, at least partially, take advantage of the difference in their vapor pressure at a particular temperature and pressure. As an example, the boiling point of Yb is 1196° C., while that of Lu is 3402° C. at standard temperature and pressure. The difference in vapor pressures at a specified temperature and pressure can be used to separate Yb and Lu via sublimation and/or distillation. Referring now to FIG. 1, graph 50 is a T-x-y diagram for lutetium and ytterbium at a constant pressure of 1 μTorr. In FIG. 1, line 54 represents the condensed phase composition at a given temperature (i.e., the bubble point), while line 52 represents the vapor phase (i.e., dew point). Graph 50 was prepared using the ideal gas and ideal solution assumptions, which are valid in view of the low pressure, high temperature, and chemical similarity of the two components.

In sublimation, the solid phase of an element is converted directly to the gas phase via heating, and the gas phase can then be collected for later use. In distillation, the solid is heated to its boiling point (going through the liquid phase) and vaporized off. The vaporized fraction can then be recovered downstream after the vapor is condensed. In this case, the ytterbium is vaporized (and it may be collected downstream for later use) leaving behind a material that is enriched in lutetium. This may be conducted on larger scale, therefore increasing the amount of lutetium available. It is noted that the ytterbium that is collected is available for recycling to a reactor, particle accelerator, or other neutron generating source, to produce further lutetium in subsequent runs of the process. Indeed, the methods described herein provide improved techniques for the recycling of collected ytterbium to improve the quantity and quality of subsequently produced lutetium.

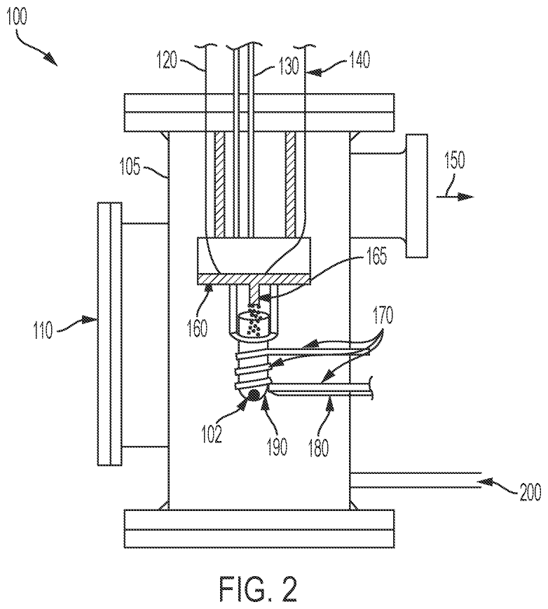

Referring now to FIG. 2, a sublimation/distillation apparatus 100 for separating rare earth elements, such as lutetium and ytterbium, is schematically depicted. The sublimation/distillation apparatus 100 includes a chamber 105 with gas, cooling, vacuum, power, and instrument feedthroughs. The sublimation/distillation apparatus 100 can generate an environment in the chamber 105 having a variety of conditions, such as high temperatures, low pressures, high levels of inert gas, and low partial pressures of select gases. The sublimation/distillation apparatus 100 comprises a crucible 190 and a heating element 170, which may be housed together in the chamber 105. The chamber 105 may also include a sealable access port 110 that provides a user with selective access to the crucible 190, for example, to access and transfer a sample contained in the crucible 190. The crucible 190 may be made of a refractory material (e.g., molybdenum or tantalum). In some embodiments, the heating element 170 is an induction heating element, such as a radiofrequency (RF) induction coil. In some embodiments, the heating element 170 is an electrical resistance heating element, for example, any known or yet-to-be-developed heating element configured to heat the crucible 190 or a crucible holder (e.g., a holding device thermally and physically coupled to the crucible 190) by electrical resistance heating. The crucible 190 may be suspended or supported within the RF induction heating coil. A temperature sensor 180 monitors the temperature of the crucible 190 and pressure sensing instrumentation 140 monitors the pressure of the chamber 105. The sublimation/distillation apparatus 100 also includes a vacuum pump connection 150 and at least one port 200 for inert gas introduction. The vacuum pump connection 150 connects the sublimation/distillation apparatus 100 to a vacuum pump, such as a turbomolecular pump, which in operation, may be used to achieve high vacuum levels.

The sublimation/distillation apparatus 100 includes a collection substrate 160, which forms a cold surface. The collection substrate 160 may be actively cooled by cooling water lines 130. The temperature of the collection substrate 160 may be monitored by a temperature sensor 120. The collection substrate 160 may also include a cold finger 165 (e.g., a cooling rod) that extends from the collection substrate 160 toward the crucible 190 and is disposed directly above the crucible 190. The cold finger 165 and the collection substrate 160 are capable of movement, which allows the open end of the crucible 190 to be open to the vacuum system (e.g., open to the chamber 105) or sealed against the collection substrate 160. In some embodiments, the cold finger 165 includes an end effector. Indeed, the cold finger 165 may extend from the collection substrate 160 toward the crucible 190 such that the cold finger 165 extends into the crucible 190 when the collection substrate 160 is sealed onto the crucible 190. Like the collection substrate 160, the cold finger 165 may also be actively cooled.

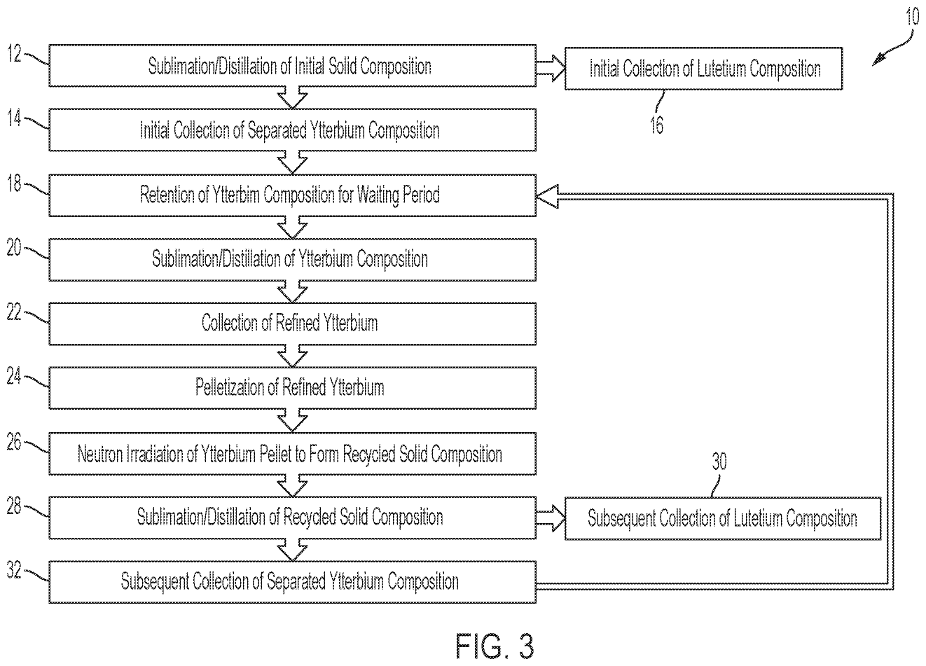

Referring now to FIG. 3, a flow chart 10 depicts a method of repeated separation of ytterbium compositions from solid compositions that comprise ytterbium and lutetium. As shown by box 12, the method includes sublimating or distilling ytterbium from an initial solid composition 102 (FIG. 2) in an inert or reduced pressure environment at a first average temperature, that is in a range of from 400° C. to 2000° C., for a first sublimation/distillation period, to leave a lutetium composition comprising a higher weight percentage of lutetium than was present in the initial solid composition 102. The first sublimation/distillation period may vary and is dependent upon the amount of material in the initial solid composition, the average temperature, and the pressure. For example, the first sublimation/distillation period may be in a range of from 1 second to 1 week and the sublimation or distillation may occur at a rate of from 100 min/g to 1 min/g of initial solid composition, for example, 80 min/g to 2 min/g, 75 min/g to 5 min/g, 75 min/g to 10 min/g, 60 min/g to 20 min/g, 60 min/g to 30 min/g, or 60 min/g to 40 min/g, such as 1 min/g of initial solid composition, 2 min/g, 5 min/g, 8 min/g, 10 min/g, 20 min/g, 25 min/g, 30 min/g, 40 min/g, 50 min/g, 60 min/g, 70 min/g, 75 min/g, 80 min/g, 90 min/g, 100 min/g, or any range having any two of these values as endpoints, or any value in a range having any two of these values as endpoints.

Moreover, during the first sublimation/distillation period, the temperature may increase from room temperature to the first average temperature at a temperature ramp rates over a period of 10 minutes to 2 hours to minimize and, in some embodiments, prevent no blistering or uneven heating of the initial solid composition 102. In some embodiments, prior to heating the initial solid composition 102, pressure in the environment (e.g., in the chamber 105 of the sublimation/distillation apparatus 100) may be reduced to degas the initial solid composition 102, for example, the pressure may be reduced to about 1×10⁻⁶ torr for about 5 minutes to 1 hour.

Referring now to FIGS. 2 and 3, the initial solid composition 102 may be contained in the crucible 190 and sublimating or distilling ytterbium from the initial solid composition 102 at box 12 may comprise heating the crucible 190, for example, using the heating element 170, such that the ytterbium composition sublimates, distills, or both sublimates and distills from the initial solid composition 102 and collects on the collection substrate 160, including, in some embodiments, on the cold finger 165. The temperature of the initial solid composition 102 may be monitored indirectly through the crucible 190, for example, using temperature sensor 180. The initial collection of ytterbium composition (e.g., “separated ytterbium composition”), for example, on the collection substrate 160, is shown by box 14 in FIG. 3. At collection, the ytterbium composition may comprise both Yb-176 and Yb-175. As shown at box 16, the lutetium composition remaining, for example, in the crucible 190, may also be collected. As noted above, the lutetium composition comprises a higher weight percentage of lutetium than was present in the initial solid composition 102. The lutetium composition collected at box 16 may be subjected to chromatographic separation to further enrich the lutetium in the lutetium composition, as described in more detail below. Alternatively, the lutetium composition collected at box 16 may be subjected to a non-aqueous separation technique to further enrich the lutetium in the lutetium composition, such as a non-aqueous, electrolytic reduction process using mercury.

Next, at box 18, the ytterbium composition is retained for a waiting period. The waiting period is longer than the first sublimation/distillation period. For example, the waiting period may be at least 4 days, for example, at least 5 days, at least 6 days, at least 1 week, at least 2 weeks, at least 3 weeks, at least 4 weeks, at least 5 weeks, at least 6 weeks, at least 7 weeks, at least 8 weeks, at least 9 weeks, at least 10 weeks, at least 11 weeks, at least 12 weeks, at least 13 weeks, at least 15 weeks, or longer, such as at least 52 weeks or at least 104 weeks. During the waiting period, the Yb-175 present in the ytterbium composition decays partially into Lu-175, forming a decayed ytterbium composition. The half-life of Yb-175 is about 4 days. Indeed, in an 8-week waiting period, 99.991% of the Yb-175 present in the ytterbium composition decays into Lu-175. In some embodiments, the ytterbium composition may be retained for a waiting period after which 50% or more of the Yb-175 present in the ytterbium composition decays into Lu-175, for example, 75% or more, 90% or more, 95% or more, 95% or more, 99.3% or more, 99.5% or more, 99.7% or more, 99.9% or more, 99.95% or more, 99.97% or more, 99.99% or more, 99.995% or more, 99.999% or more, or 99.9999% or more.

Lu-175 is stable and non-radioactive. Lu-175 is also a contaminant in Lu-177 based radiopharmaceuticals. Lu-175 degrades the specific activity of Lu-177 based radiopharmaceuticals because it is stable and non-radioactive. Lu-175 can also lead to the formation of Lu-176m during the next irradiation of the process described herein (e.g., at the step show by box 26 in FIG. 3). Minimizing Lu-175 and Lu-176m may be required to meet purity requirements for some radiopharmaceutical products. Table 1, below, includes additional details for Lu-175 and Lu-176. As shown in Table 1, the production of Lu-177m2 occurs from Lu-176 and has a half-life of approximately 160 days, which poses a hazard to patients as it can remain in the body and potentially result in off-target cell damage.

TABLE 1

| | Atomic | | σ₀, | Activation | | Decay | Main γ rays in KeV |
|---|---|---|---|---|---|---|---|
| Element | Mass | Abundance | barn | Product | T_{1/2} | Product(s) | (absolute intensity, %) |
| Lu | 175 | 97.41% | 16.7 ± | ^{176m}Lu | 3.664 | ¹⁷⁶Hf | 88.36 (8.9) |
| | | | 0.4 | | hours | | |
| | | | 6.6 ± | ¹⁷⁶Lu | 4 × 10¹⁰ | ¹⁷⁶Hf | 88.34 (14.5), 201.83 |
| | | | 1.3 | | years | | (78.0), 306.78 (93.6) |
| | 176 | 2.59% | 317 ± | ^{177m1}Lu | 6 | N/A | N/A |
| | | | 58 | | mins | | |
| | | | 2.8 ± | ^{177m2}Lu | 160.44 | ¹⁷⁷Hf | 112.95 (21.9), 128.5 |
| | | | 0.7 | | days | (78.6%) | (15.6), 153.28 (17.0), |
| | | | | | | ¹⁷⁷Lu | 204.11 (13.9), 208.37 |
| | | | | | | (21.4%) | (57.4), 228.48 (37.2), |
| | | | | | | | 281.79 (14.2), 327.68 |
| | | | | | | | (18.1), 378.5 (29.9), |
| | | | | | | | 418.54 (21.3) |
| | | | 2020 ± | ¹⁷⁷Lu | 6.647 | ¹⁷⁷Hf | 112.95 (6.17), 136.72 |
| | | | 70 | | days | | (0.05), 208.37 (10.36), |
| | | | | | | | 249.67 (0.20), 321.32 |
| | | | | | | | (0.31) |

Retaining the ytterbium composition allows most of the Yb-175 to decay to Lu-175 and form the decayed ytterbium composition. This allows the Lu-175 to be removed from the decayed ytterbium composition with an additional sublimation step. Indeed, subsequent to the waiting period, at box 20, the method further comprises sublimating or distilling a refined ytterbium composition from the decayed ytterbium composition in an inert or reduced pressure environment and at a temperature of 400° C. to 2000° C., for example, using the sublimation/distillation apparatus 100 (or a different sublimation/distillation apparatus) to leave a waste composition that includes the newly formed Lu-175 (e.g., the Lu-175 formed by decay during the waiting period). For example, the refined ytterbium composition may collect on the collection substrate 160 and/or cold finger 165 of the sublimation/distillation apparatus 100 and the waste composition may remain in the crucible 190. The refined ytterbium composition comprises 0.1 weight percent (wt. %) Lu-175 or less, for example, 0.05 wt. % or less, 0.02 wt. % or less, 0.01 wt. % or less, 0.005 wt. % or less, 0.004 wt. % or less, 0.003 wt. % or less, 0.002 wt. % or less, 0.001 wt. % or less, 0.0005 wt. % or less, 0.0001 wt. % or less, or a value in a range having any two of these values as endpoints. Moreover, in embodiments in which the waste composition comprises 10 mg or more of an ytterbium oxide, the method may further comprise dissolving the ytterbium oxide and metalizing the dissolved ytterbium into a ytterbium metal, which can be refined for reuse.

By separating the refined ytterbium composition and the waste composition, the refined ytterbium composition comprises a higher weight percentage of ytterbium than was present in the decayed ytterbium composition. In addition to Lu-175, the waste composition may further comprise one or more ytterbium oxides, one or more ytterbium silicates, and elements with a low vapor pressure, such as lanthanum, iron, aluminum, nickel, copper, cerium, tin, erbium, cobalt, silicon, chromium, tantalum, titanium, molybdenum, manganese, and mixtures and alloys thereof. Each of these is undesirable in a Lu-177 based radiopharmaceutical. Moreover, these impurities may also be undesirable when the refined ytterbium composition is irradiated (at 26, below). Without intending to be limited by theory, the impurities could cause an excessive radiative does to facility operators if the impurities were irradiated and activated in a neutron source facility, such as a reactor. In other words, removing the waste composition from the decayed ytterbium composition (i.e., forming the refined ytterbium) acts as a purification step to remove the impurities from the decayed ytterbium composition, impurities that form the waste composition.

Referring still to FIGS. 2 and 3, at box 22, the method next comprises collecting the refined ytterbium composition and, at box 24, forming (e.g., pressing, pelletizing, or the like) the refined ytterbium composition into a ytterbium target. In some embodiments, the ytterbium target comprises a ytterbium pellet, which may be formed by pelletizing the refined ytterbium composition. The ytterbium pellet may comprise a variety of shapes, such as a spherical shape, a cylindrical shape, an oblong shape, or the like. In some embodiments, the ytterbium target comprises a ytterbium foil. The ytterbium target is substantially homogenous to facilitate uniform heat transfer and uniform irradiation. Next, at box 26, the ytterbium target may be irradiated with neutrons to form a recycled solid composition comprising ytterbium and lutetium. The ytterbium target may be irradiated by neutrons generated using a nuclear reactor, a particle accelerator, such as an ion beam source, or any other known or yet to be developed neutron source. In some embodiments, at box 26, the ytterbium target is packaged into a tube, which may have sealable ends. For example, the tube may be a quartz tube or a titanium tube and the tube may have a diameter in a range of from 0.5 cm to 2 cm, such as a 1 cm diameter. The tube is then places in an inert overpack (e.g., aluminum) suitable for irradiation. In some embodiments, the inert overpack is sealed and impervious to water or air ingress. In other embodiments, the inert overpack is unsealed. The inert overpack is irradiated by neutrons generated using a nuclear reactor, a particle accelerator, such as an ion beam source, or any other known or yet to be developed neutron source, for several hours to several days (dependent on flux and batch requirements) to generate Lu-177 within the Yb-176 target, forming the recycled solid composition.

After neutron irradiation, the recycled solid composition may be returned to the sublimation/distillation apparatus 100 (or a different sublimation distillation apparatus) for additional processing. For example, the sealed overpack housing the recycled solid composition may be loaded into a processing hotcell or isolator. Within the hotcell or isolator, which may comprise an inert environment, the irradiated Yb metal target is removed and placed inside the crucible 190 and placed in the chamber 105 of the sublimation/distillation apparatus 100 (or a different sublimation/distillation apparatus), for an additional sublimation/distillation step. Indeed, at box 28, that method next comprises sublimating or distilling an ytterbium composition (e.g., a subsequent ytterbium composition) from the recycled solid composition in an inert or reduced pressure environment and at a third average temperature that is in a range of from 400° C. to 2000° C. for a third sublimation/distillation period to leave a subsequent lutetium composition comprising a higher weight percentage of lutetium than was present in the recycled solid composition. The third sublimation/distillation period may be the same length as the first sublimation/distillation period and may operate at the same temperature ramp rate, temperature, and pressure. Next, at box 30, the subsequent lutetium composition is collected and at box 32 the subsequent ytterbium composition is also collected. The process may then be repeated on the subsequent ytterbium composition, starting at box 18. That is, the subsequent ytterbium composition is retained for the waiting period, sublimated or distilled to remove the waste composition (box 20), collected (box 22), formed (box 24), irradiated (box 26), and sublimated/distilled to separate and collect additional lutetium (boxes 28 and 30). This process may be repeated a number of times to collect additional lutetium.

Referring still to FIGS. 2 and 3, at boxes 16 and 30, the generated lutetium composition is collected once the crucible 190 cools. Once the crucible 190 cools, for example, to a temperature of 150° C. or less, such as 100° C. or less, 80° C. or less, or 50° C. or less, the lutetium compositions are dissolved in an acid to remove them from the crucible 190 and for transfer to a chromatographic separation apparatus. The crucible 190 may be cooled passively (e.g., by removing the application of heat by the heating element 170 and waiting a period of time) or actively. Indeed, similar to the lutetium composition collected at box 16, the lutetium composition collected at box 30 may be subjected to chromatographic separation to further enrich the lutetium in the composition or sample, as described in more detail below.

Referring still to FIGS. 2 and 3, the each of the first average temperature of the first sublimation/distillation period, the second average temperature of the second sublimation/distillation period, and the third average temperature of the third sublimation/distillation period, may be in a range of from 400° C. to 2000° C., for example, from 450° C. to 1500° C., from 450° C. to 1200° C., from 450° C. to 1000° C., from 400° C. to 1000° C., from 400° C. to 900° C., from 400° C. to 800° C., from 450° C. to 700° C., from 400° C. to less than 700° C., from 400° C. to 695° C., from 450° C. to 690° C., from 450° C. to 685° C., from 450° C. to 680° C., from 450° C. to 675° C., from 450° C. to 670° C., from 450° C. to 665° C., from 450° C. to 660° C., from 450° C. to 655° C., from 450° C. to 650° C., from 450° C. to 645° C., from 450° C. to 640° C., from 450° C. to 635° C., from 450° C. to 630° C., from 450° C. to 625° C., 470° C. to about 630° C., from 800° C. to 2000° C., from greater than 800° C. to 2000° C., from 1000° C. to 2000° C., from 1200° C. to 2000° C., from 1500° C. to 2000° C., or any range having any two of these values as endpoints. Indeed, the temperature for sublimation and/or distillation (e.g., the temperature in the environment) may be 400° C., 425° C., 450° C., 470° C., 475° C., 500° C., 525° C., 550° C., 575° C., 600° C., 625° C., 640° C., 650° C., 655° C., 660° C., 665° C., 670° C., 675° C., 680° C., 685° C., 690° C., 695° C., 698° C., 700° C., 725° C., 750° C., 775° C., 800° C., 850° C., 900° C., 950° C., 1000° C., 1100° C., 1200° C., 1300° C., 1400° C., 1500° C., 1600° C., 1700° C., 1800° C., 1900° C., 2000° C., any range having any two of these values as endpoints, or any value in a range having any two of these values as endpoints. In some embodiments, the first average temperature, the second average temperature, and the third a average temperature are equal or differ by less than 100° C.

Also, according to various embodiments, the pressure of the environment at any of the temperatures and temperature ranges described above and during any of the first, second, and third sublimation/distillation periods, may be in a range of from 2000 torr to 1×10⁻⁸, from 1520 torr to 1×10⁻⁸ torr, from 1000 torr to 1×10⁻⁸ torr, from 760 torr to 1×10⁻⁸ torr, from 700 torr to 1×10⁻⁸ torr, from 500 torr to 1×10⁻⁸ torr, from 250 torr to 1×10⁻⁷ torr, from 100 torr to 1×10⁻⁶ torr, from 1 torr to 1×10⁻⁶ torr, from 1×10⁻¹ torr to 1×10⁻⁶ torr, 1×10⁻³ torr or less, 1×10⁻⁵ torr or less, 1×10⁻⁶ torr or less, from 2000 torr to 1×10⁻¹ torr, from 1520 torr to 1 torr, from 1000 torr to 1 torr, from 760 torr to 1 torr, from 760 torr to 250 torr, any range having any two of these values as endpoints, or any value in a range having any two of these values as endpoints.

At boxes 18 and 30, sublimation/distillation process yields a lutetium composition (e.g., the “initial collection of lutitium composition” and the “subsequent collection of lutetium composition”) that is enriched in lutetium as compared to the initial or recycled solid composition that enters the process. The yields and purity may be measured in several ways. For example, in some embodiments, the process yields an ytterbium mass reduction of the initial or recycled solid composition from 10:1 to 10000:1, such as 25:1, 50:1, 75:1, 50:1, 150:1, 200:1, 400:1, 500:1, 750:1, 1000:1, 2000:1, 3000:1, 4000:1, 5000:1, 6000:1, 7000:1, 8000:1, 9000:1, or any range having any two of these values as endpoints, or a value in a range having any two of these values as endpoints. In other words, after the sublimation/distillation is completed, there is 10 to 10000 times less ytterbium in the sample than prior to the process (i.e., than was present in the initial or recycled solid composition). In the lutetium composition that is recovered (i.e., the contents in the crucible that is subjected to the acid dissolution), there may, in some embodiments, be from 1 wt. % to 90 wt. % of ytterbium relative to total remaining mass that will then be separated as described below in a chromatographic process. In other embodiments, the ytterbium that is collected from the sublimation/distillation is collected in an amount that is from 90 wt. % to 99.999 wt. % of the ytterbium present in the initial or recycled solid composition. The purification steps are also conducted to remove other trace metals and contaminants. For example, materials such as metals, metal oxides, or metal ions of K, Na, Ca, Fe, Al, Si, Ni, Cu, Pb, La, Ce, Lu (non-radioactive), Eu, Sn, Er, and Tm may be removed. Stated another way, the methods described herein include subjecting a sample comprising Yb-176 and Lu-177 to sublimation, distillation, or a combination thereof to remove at least a portion of the Yb-176 from the sample and form a Lu-177-enriched sample.

It has been observed that a purification that is a 100:1 reduction (i.e. a 100 times reduction in the amount of Yb present) or greater in Yb may be achieved, for example, a purification of 200:1 or greater, 500:1 or greater, 1000:1 or greater, 2000:1 or greater, 4000:1 or greater, 8000:1 or greater, 10000:1 or greater, up to and including approximately 40,000:1. However, higher reductions in Yb may be required to meet purity requirements for some pharmaceutical products. Accordingly, additional purification may be conducted prior to use in pharmaceutical applications. Such purification may be obtained using chelators and/or chromatographic separation.

Any of the above lutetium compositions or lutetium-enriched samples, as described herein, may be subjected to chromatographic separation to further enrich the lutetium in the composition or sample. Such chromatographic separations may include column chromatography, plate chromatography, thin cell chromatography, or high-performance liquid chromatography. Illustrative processes for purification of lutetium may be as described in U.S. Pat. Nos. 7,244,403 and 9,816,156, both of which are incorporated herein by reference in their entirety. However, it should be understood that other chromatographic separation techniques may be used to further enrich the lutetium separated using the techniques described herein. In one aspect, a process may include dissolving in an acid the lutetium and ytterbium composition that remains in the crucible after sublimation and applying the resultant solution to a chromatographic column or plate. This may include plate chromatographic materials, chromatographic columns, HPLC chromatographic columns, ion exchange columns, and the like.

As an illustrative example, a solution of lutetium in dilute HCl may be prepared (i.e. 0.01-5 N HCl). This may be applied to a solution packed, or dry, ion exchange column, and the lutetium eluted with additional washes of dilute HCl. This is generally described by U.S. Pat. No. 7,244,403 as that the solution susceptible to treatment is generally a dilute solution of a strong acid, usually HCl. The bed of resin which may be in the form of a strong anion exchange resin in a column and the contacting occurs by flowing the solution through the column. In some embodiments, the resin is a strongly basic anion exchange resin which is about 8% cross linked. First, an HCl solution is flowed through the column to form an HCl-treated column, then flowing an NaCl solution through the HCl treated column to form an NaCl treated column, and then flowing sterile water through the NaCl-treated column. These preparative steps assist in eluting a sterile, nonpyrogenic product. The resin may then be dried prior to application of the lutetium solution. In some embodiments, the anion exchange resin is in a powdered form, generally having particles in the size of from 100 mesh to 200 mesh. To speed solution flow though the column, a sterile gas pressure may be applied to the head of the column. This can be carried out by injecting a sterile gas, preferably air, into an upper end of the column to push the solution of Lu-177 through the column. The Lu-177 recovered from such a process may be in a higher purity than prior to the column chromatography through the anion exchange column.

In another aspect, a process may include the use of a cation exchange resin for the purification of lutetium from a composition that also include ytterbium (e.g., further separation of any ytterbium remaining in the lutetium composition). As an illustrative example, and as generally described by U.S. Pat. No. 9,816,156, the method includes loading a first column packed with cation exchange material, with the Lu/Yb mixture is dissolved in a mineral acid, exchanging the protons of the cation exchange material for ammonium ions, thereby using an NH₄Cl solution, and washing the cation exchange material of the first column with water. An outlet of the first column is linked with the inlet of a second column that is also packed with a cation exchange material. A gradient of water and a chelating agent is then applied to the column starting at 100% of H₂O to 0.2 M of the chelating agent on the inlet of the first column, so as to elute the lutetium from the first and second column. Illustrative examples of chelators include, but are not limited to, α-hydroxyisobutyrate [MBA], citric acid, citrate, butyric acid, butyrate, EDTA, EGTA and ammonium ions. The method may also include determining the radioactivity dose on the outlet of the second column in order to recognize the elution of Lu-177 compounds; and collecting a first Lu-177 eluate from the outlet of the second column in a vessel, followed by protonating the chelating agent so as to inactivate same for the complex formation with Lu-177. The method may also include loading a final column packed with a cation exchange material by continuously conveying the acidic lutetium eluate to the inlet of the final column, washing out the chelating agent with diluted mineral acid of a concentration lower than approximately 0.1 M, removing traces of other metal ions from the lutetium solution by washing the cation exchange material of the final column with mineral acid of various concentrations in a range of approximately 0.01 to 2.5 M; and eluting the Lu-177 ions from the final column by way of a highly concentrated mineral acid of approximately 1M to 12M. Finally, an eluent containing higher purity lutetium than what was applied to the columns may be collected, and the solvent and mineral acid removed by vaporization.

In a further aspect, a process may include dissolving the lutetium composition (which may include some remaining ytterbium) in an acid to form a dissolved lutetium/ytterbium solution, adding a chelator to the dissolved lutetium/ytterbium solution and neutralizing with a base to form a chelated lutetium/ytterbium solution comprising both chelated lutetium and ytterbium, and subjecting the chelated solution to chromatographic separation, collecting a purified, chelated lutetium fraction, and de-chelating the lutetium to obtain purified lutetium. The purified, chelated lutetium fraction has a purity of lutetium higher than that of the lutetium in the dissolved lutetium/ytterbium solution. Using such a chromatographic process high levels of lutetium purity may be obtained. For example, the purified lutetium obtained after chromatographic separation and work-up may include Lu-177 that is greater than 99% pure on an isotopic basis. This includes Lu-177 that is greater than 99.9%, greater than 99.99%, greater than 99.999%, or greater than 99.9999% pure on an isotopic basis.

Using previous techniques, a ytterbium metal or metal oxide target is irradiated to form Lu-177. The target is then dissolved in an acid, a chelator is added, and the solution neutralized with a base to form a chelated metal, chromatographic separation is conducted, and the purified metal is then decomplexed/de-chelated from the chelator. However, due to the limits of chromatography, by starting with an impure source of lutetium (i.e. the irradiated ytterbium oxide target), the efficiency of the chromatography is low, with only small fractions of purified lutetium being obtained with each chromatographic cycle, even on a preparative scale. Using the purified lutetium after distillation/sublimation, as described above, provides a surprising benefit in producing higher purity rare earth metals, particularly lutetium, that are not obtainable by either distillation or chromatography alone, on a larger scale, and in a shorter period of time.

The initial dissolution in an acid of the lutetium may be conducted using hydrofluoric, hydrochloric, hydrobromic, hydroiodic, sulfuric, nitric, peroxosulfuric, perchloric, methanesulfonic, trifluoromethanesulfonic, formic, acetic, trifluoroacetic acid, or a mixture of any two or more thereof. A concentration of the acid may be from 0.01 M to 6 M and/or a concentration of the base is from 0.01 M to 6 M. This includes concentrations of from 1 M to 6 M and from 2 M to 6 M. The chelator is then added along with a base (e.g. lithium hydroxide, sodium hydroxide, potassium hydroxide, NH₄OH, or an alkylammonium hydroxide) to neutralize the acid an produce the chelated lutetium. The chelated Lu-177 does contain other impurities at this point. For example, it will contain Yb, and it may contain K, Na, Ca, Fe, Al, Si, Ni, Cu, Pb, La, Ce, Lu (other than Lu-177), Eu, Sn, Er, and Tm. HPLC is then conducted. The HPLC may be conducted on a appropriate column and eluted with an appropriate mobile phase, each of which may change under different method development scenarios. As one example, the column may be a cation exchange column, an anion exchange column, a reversed phase C18 column, and the like and the mobile phase may any that is determined to achieve separation.

For further purification, the chelated Lu-177 is then applied to a high-performance liquid chromatography (HPLC) system (reversed phase C18 column with 12-14 vol % methanol) from which chelated Lu-177 is then eluted at a higher purity then when it was applied to the column. Acidification with HCl of the chelated Lu-177 releases it from the chelator as the chloride salt.

The mobile phase may be aqueous- or organic solvent-based. Illustrative examples include, but are not limited to water, alcohols, alkanes, ethers, esters, acids, bases, and aromatics. In various embodiments, the mobile phase may include water, methanol/water, methanol/trifluoroacetic acid/water, and/or methanol mobile phase.

After purification via HPLC of the chelated lutetium, there is a de-chelating process that is conducted to obtain the purified lutetium as a lutetium solution and/or ionic material. In some embodiments, the de-chelating includes contacting the purified, chelated lutetium fraction with an acid that is hydrofluoric, hydrochloric, hydrobromic, hydroiodic, sulfuric, nitric, peroxosulfuric, perchloric, methanesulfonic, trifluoromethanesulfonic, formic, acetic, trifluoroacetic acid, or a mixture of any two or more thereof. A concentration of the acid may be from 0.01 M to 6 M and/or a concentration of the base is from 0.01 M to 6 M. This includes concentrations of from 1 M to 6 M and from 2 M to 6 M.

As discussed above, the process described herein may be used for the separation of lutetium and ytterbium. However, it may be used to separate any of the rare earth, and/or actinide metals where there is a difference in boiling/sublimation point followed by further purification using the chromatographic separations in the presence of the various chelators. In the above chelators, rare earth elements that may be chelated for purification include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y). In some embodiments, the methods include the chromatographic separation of rare earth elements from a mixture of at least two metal ions, where at least one of them is Ce, Dy, Er, Eu, Gd, Ho, La, Lu, Nd, Pr, Pm, Sm, Sc, Tb, Tm, Yb or Y.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
sublimating or distilling an ytterbium composition from an initial solid composition comprising ytterbium and lutetium in an inert or reduced pressure environment and at a first average temperature in a range of from 400° C. to 2000° C. for a first sublimation/distillation period to leave a lutetium composition comprising a higher weight percentage of lutetium than was present in the initial solid composition,
collecting the ytterbium composition;
retaining the ytterbium composition for a waiting period to form a decayed ytterbium composition, wherein the waiting period is longer than the first sublimation/distillation period; and
subsequent to the waiting period, sublimating or distilling a refined ytterbium composition from the decayed ytterbium composition in an inert or reduced pressure environment and at a second average temperature in a range of from 400° C. to 2000° C. for a second sublimation/distillation period to leave a waste composition.

2. The method of claim 1, further comprising collecting the refined ytterbium composition.

3. The method of claim 2, further comprising forming the refined ytterbium composition into a ytterbium target.

4. The method of claim 3, further comprising irradiating the ytterbium target with neutrons to form a recycled solid composition comprising ytterbium and lutetium.

5. The method of claim 4, further comprising sublimating or distilling an ytterbium composition from the recycled solid composition in an inert or reduced pressure environment and at a third average temperature in a range of from 400° C. to 2000° C. for a third sublimation/distillation period to leave a subsequent lutetium composition comprising a higher weight percentage of lutetium than was present in the recycled solid composition.

6. The method of claim 1, wherein the refined ytterbium composition comprises 0.01 wt. % Lu-175 or less.

7. The method of claim 1, wherein the waste composition comprises Lu-175 and at least one of one or more ytterbium oxides, one or more ytterbium silicates, lanthanum, iron, aluminum, nickel, copper, cerium, tin, erbium, cobalt, silicon, chromium, tantalum, titanium, molybdenum, manganese, and mixtures and alloys thereof.

8. The method of claim 7, wherein the waste composition comprises 10 mg or more of an ytterbium oxide and the method further comprises dissolving the ytterbium oxide to form a dissolved ytterbium oxide and metalizing the dissolved ytterbium.

9. The method of claim 1, wherein the ytterbium composition comprises Yb-176 and Yb-175 and during the waiting period the Yb-175 decays partially into Lu-175 to form the decayed ytterbium composition and sublimating or distilling the refined ytterbium composition from the decayed ytterbium composition separates Yb-176 and Lu-175.

10. The method of claim 9, wherein the refined ytterbium composition comprises Yb-176 and the waste composition comprises Lu-175.

11. The method of claim 1, wherein the waiting period is at least 1 week.

12. The method of claim 1, wherein, during the waiting period, 90% or more of Yb-175 present in the ytterbium composition decays into Lu-175.

13. The method of claim 1, wherein, during the waiting period, 99% or more of Yb-175 present in the ytterbium composition decays into Lu-175.

14. The method of claim 1, wherein the reduced pressure is 1×10⁻³ or less and the first average temperature is in a range of from 450° C. to 1500° C.

15. The method of claim 1, wherein the first average temperature is less than 700° C.

16. The method of claim 1, wherein the first average temperature and the second average temperature are equal or differ by less than 100° C.

17. The method of claim 1, further comprising subjecting the lutetium composition to chromatographic separation to further enrich the lutetium in the lutetium composition.

18. The method of claim 17, further comprising, dissolving the lutetium composition in an acid to form a dissolved lutetium solution, adding a chelator to the dissolved lutetium solution and neutralizing with a base to form a chelated lutetium solution comprising both chelated lutetium and ytterbium, and subjecting the chelated lutetium solution to chromatographic separation, collecting a purified, chelated lutetium fraction, and de-chelating the lutetium to obtain purified lutetium.

19. The method of claim 1, wherein the initial solid composition is contained in a crucible of a sublimation/distillation apparatus and subliming or distilling ytterbium from the initial solid composition comprises heating the crucible such that the ytterbium composition sublimates, distills, or both sublimates and distills from the initial solid composition and collects on a collection substrate of the sublimation/distillation apparatus.

20. The method of claim 1, wherein the refined ytterbium composition comprises a higher weight percentage of ytterbium than was present in the decayed ytterbium composition.
